(19) United States
(12) Patent Application Publication
(10) Pub. No.: US 2026/0166824 A1
(43) Pub. Date: Jun. 18, 2026

(54) SEALS AND METHODS FOR RESIN TRANSFER INFUSION

(71) Applicant: The Boeing Company, Arlington, VA (US)

(72) Inventors: Carlos Bello, Madrid (ES); Stephen L. Belcher, Doncaster (GB)

(21) Appl. No.: 19/416,718

(22) Filed: Dec. 11, 2025

Related U.S. Application Data
(60) Provisional application No. 63/733,199, filed on Dec. 12, 2024.

(51) Int. Cl. B29C 70/48; B29C 33/00

(52) U.S. Cl. CPC B29C 70/48; B29C 33/0038

(57) ABSTRACT

Methods of resin transfer infusion and maintaining a clean resin infusion tool, a seal, and a resin infusion tool are presented. A resin infusion tool comprises a first mold; a second mold configured to form a resin infusion chamber with the first mold, wherein the second mold comprises at least one channel around a perimeter of the second mold; and at least one seal seated within the at least one channel of the second mold, the at least one seal is seated so as to maintain a vacuum seal between the first mold and the second mold in both a infusion position and a closed position of the resin infusion tool, wherein the seal is in contact with the first mold in the infusion position, and wherein the seal is compressed in the closed position.

### CROSS-REFERENCE TO RELATED APPLICATION

This application claims the benefit of U.S. Provisional Patent Application Ser. No. 63/733,199, filed Dec. 12, 2024, and entitled “SEALS AND METHODS FOR RESIN TRANSFER INFUSION,” which is incorporated herein by reference in its entirety.

### BACKGROUND INFORMATION

### 1. Field

The present disclosure relates generally to composite manufacturing and more specifically to gap resin transfer infusion.

### 2. Background

In gap resin transfer infusion, resin is introduced into a resin infusion chamber between an upper mold and a lower mold when the resin infusion tool is in a infusion position. The resin is forced into a dry preform within the resin infusion chamber by moving the upper mold downward towards the lower mold and into a closed position.

The resin infusion chamber in the resin infusion tool remains sealed in the two different positions. Conventional resin transfer molding tool design uses circular solid elastomeric extrusions. The extrusions are often butt-joined and sealed with sealing tape which needs to be removed and cleaned after each cycle. Conventional seals are typically replaced every cycle. Additionally, resin flash and debris are cleaned from the resin infusion tool for every cycle.

The seal replacement and tool cleaning undesirably contribute additional time between cycles. The seal replacement adds undesirable resource costs.

Therefore, it would be desirable to have a method and apparatus that takes into account at least some of the issues discussed above, as well as other possible issues. For example, it would be desirable to provide reusable seals for resin transfer molding.

### SUMMARY

An embodiment of the present disclosure provides a seal configured to maintain pressure in at least two different positions. The seal comprises a polymeric material in an extruded cross-sectional shape, the cross-sectional shape comprising a substantially flat first end and a projection opposite the substantially flat first end.

Another embodiment of the present disclosure provides a resin infusion tool. The resin infusion tool comprises a first mold; a second mold configured to form a resin infusion chamber with the first mold, wherein the second mold comprises at least one channel around a perimeter of the second mold; and at least one seal seated within the at least one channel of the second mold, where the at least one seal is seated so as to maintain a vacuum seal between the first mold and the second mold in a infusion position of the resin infusion tool in which the seal is in contact with the first mold and in a closed position of the resin infusion tool in which the seal is compressed.

Yet another embodiment of the present disclosure provides a method of resin transfer infusion. A dry fiber preform is placed between a first mold of a resin infusion tool and a second mold of the resin infusion tool, wherein the resin infusion tool comprises a seal seated within a channel of the second mold. The first mold of the resin infusion tool is placed into contact with the seal to a infusion position of the resin infusion tool. Vacuum is pulled within a resin infusion chamber between the second mold and the first mold while the resin infusion tool is in the infusion position. Resin is injected into the resin infusion chamber while under vacuum. The resin infusion tool is closed to a closed position to infuse the resin into the dry fiber preform while under vacuum to form a resin infused fiber preform, wherein the seal is compressed in the closed position.

A further embodiment of the present disclosure provides a method of maintaining a clean resin infusion tool. A resin infusion tool is closed to a closed position to infuse resin into a dry fiber preform within a resin infusion chamber between an first mold and a second mold of the resin infusion tool to form a resin infused fiber preform, wherein closing the resin infusion tool to the closed position forms a flash formation region. The resin infused fiber preform is cured with the resin infusion chamber while the resin infusion tool is in the closed position to form a cured part. The first mold is lifted away from the second mold after curing the resin infused fiber preform. The cured part and connected resin flash are demolded from the second mold.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is a cross-sectional view through a seal in a portion of a resin infusion tool in an open position in accordance with an illustrative embodiment;

FIG. 4 is a cross-sectional view through a seal in a portion of a resin infusion tool in a infusion position in accordance with an illustrative embodiment;

FIG. 5 is a cross-sectional view through a seal in a portion of a resin infusion tool in a infusion position in accordance with an illustrative embodiment;

FIG. 6 is a cross-sectional view through a seal in a portion of a resin infusion tool in a closed position in accordance with an illustrative embodiment;

FIG. 7 is a cross-sectional view through a seal in a portion of a resin infusion tool in an open position after resin infusion in accordance with an illustrative embodiment;

FIG. 8 is a cross-sectional view through a seal in a portion of a resin infusion tool in an open position after resin infusion in accordance with an illustrative embodiment;

FIG. 9 is a cross-sectional view through a seal in a portion of a resin infusion tool in an open position in accordance with an illustrative embodiment;

FIG. 10 is a cross-sectional view through a seal in a portion of a resin infusion tool in a closed position in accordance with an illustrative embodiment;

FIG. 11 is a cross-sectional view through a seal in a portion of a resin infusion tool in an open position in accordance with an illustrative embodiment;

FIG. 12 is a cross-sectional view through a portion of a resin infusion tool with seals visible in accordance with an illustrative embodiment;

FIG. 13 is a cross-sectional view through a portion of a resin infusion tool with seals visible in accordance with an illustrative embodiment;

FIG. 14 is a cross-sectional view through a portion of a resin infusion tool with seals visible in accordance with an illustrative embodiment;

FIG. 15 is a flowchart of a method of resin transfer infusion in accordance with an illustrative embodiment;

FIG. 16 is a flowchart of a method of maintaining a clean resin infusion tool in accordance with an illustrative embodiment;

FIG. 17 is an illustration of an aircraft manufacturing and service method in a form of a block diagram in accordance with an illustrative embodiment; and

FIG. 18 is an illustration of an aircraft in a form of a block diagram in which an illustrative embodiment may be implemented.

### DETAILED DESCRIPTION

The illustrative examples recognize and take into account several considerations. The illustrative examples recognize and take into account that current State-of-the-art resin transfer molding (RTM) tool design replaces the seals after the part is cured so that the tool can be cleaned from thin resin flash debris.

The illustrative examples recognize and take into account that typical resin transfer molding tool design use circular solid elastomeric extrusions. The illustrative examples recognize and take into account that seal ends are normally butt-joined. The illustrative examples recognize and take into account that the diameter used to cope with gap-resin infusion process is large and used in conjunction with a “dove tail” groove to keep the seal in place. The illustrative examples recognize and take into account that no other feature maintains the seal within the groove and achieves vacuum. The illustrative examples recognize and take into account that the conventional circular seal cross-section is meant to be deformed in the groove where the resin easily fills the corners before the injection is taking place. The illustrative examples recognize and take into account that this resin is then removed when the seal is replaced.

The illustrative examples recognize and take into account that to avoid potential leaks, tools often feature a double groove where a second “safety” seal is installed. The illustrative examples recognize and take into account that the butt joints on typical extrusions are normally placed on opposite locations to avoid sealing failure.

The illustrative examples recognize and take into account that three-surface joints are typically points of failure where seals ends are normally physically butt-joined. The butt-joints include additional considerations and disposable materials (like sealing tape) to ensure vacuum integrity.

The illustrative examples enable Gap-Resin Infusion parts to be manufactured in high-rate scenarios. The illustrative examples recognize and take into account that high-rate manufacturing aims to avoid resin debris and reuse the seals to reduce takt time and cut process cost.

The illustrative examples avoid resin debris by designing resin flash that is thick enough that it does not break off during demolding. At the same time, the seal withstands multiple cure cycles without being damaged. The illustrative examples present methods of resin transfer infusion, seals, and a resin infusion tool for avoiding resin debris.

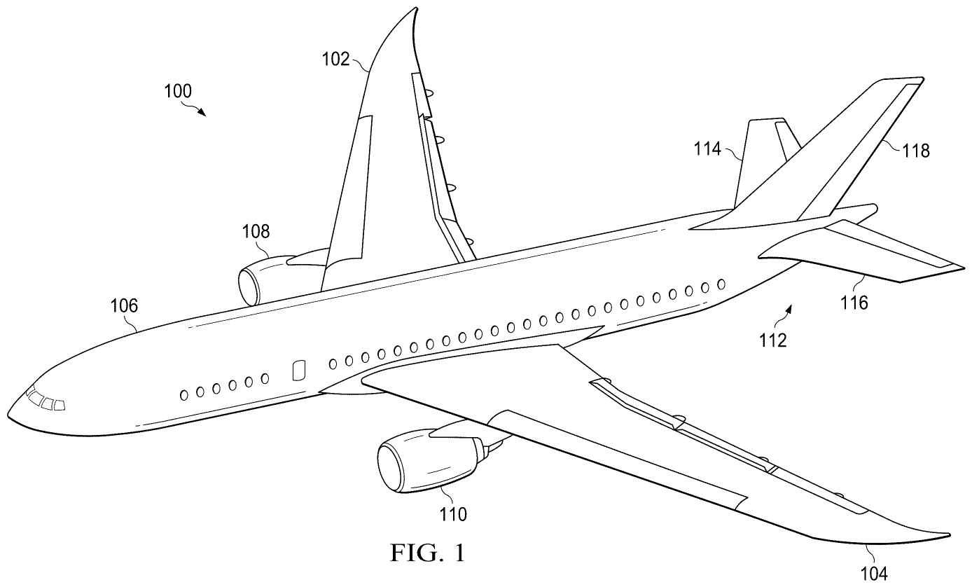

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite parts manufactured using the illustrative examples. In some illustrative examples, at least a portion of wing 102, wing 104, or body 106 can be manufactured using the illustrative examples.

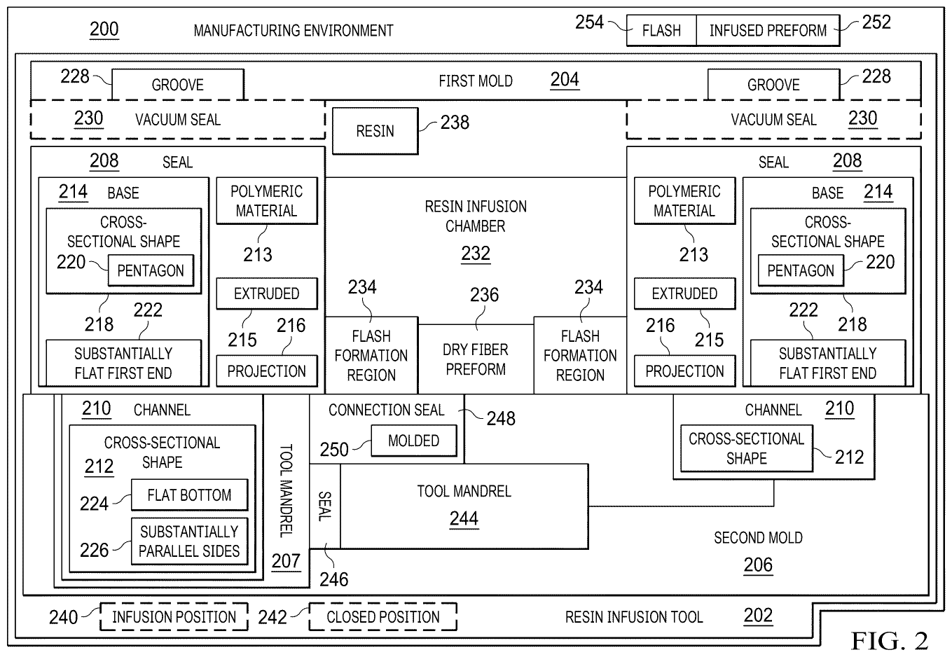

Turning now to FIG. 2, an illustration of a block diagram of a manufacturing environment is depicted in accordance with an illustrative embodiment. Resin infusion tool 202 in manufacturing environment 200 can be used to form a composite part of aircraft 100 of FIG. 1.

Resin infusion tool 202 comprises first mold 204, second mold 206 configured to form resin infusion chamber 232 with first mold 204, and seal 208 seated within channel 210 of second mold 206. second mold 206 comprises channel 210 around a perimeter of second mold 206. Seal 208 is configured to maintain vacuum seal 230 between first mold 204 and second mold 206 in both infusion position 240 and closed position 242 of resin infusion tool 202. Seal 208 is in contact with first mold 204 in infusion position 240, and seal 208 is compressed in closed position 242. Seal 208 is seated so as to maintain vacuum seal 230 between first mold 204 and second mold 206 in both infusion position 240 and closed position 242 of resin infusion tool 202. Seal 208 is in contact with first mold 204 in infusion position 240, and seal 208 is compressed in closed position 242. Additionally, seal 208 is designed to maintain vacuum seal 230 between first mold 204 and second mold 206 in both infusion position 240 and closed position 242 of resin infusion tool 202. Seal 208 is in contact with first mold 204 in infusion position 240, and seal 208 is compressed in closed position 242.

Resin infusion chamber 232 can be referred to as a sealed chamber. First mold 204 can take the form of either an upper mold or a lower mold. In this non-limiting illustrative example, first mold 204 is depicted as an upper mold and second mold 206 is a lower mold. Second mold 206 can take the form of either an upper mold or lower mold. As second mold 206 can be either an upper mold or lower mold, seal 208 can be present in either an upper mold or a lower mold.

Seal 208 is configured to seal resin infusion chamber 232 for application of vacuum in both closed position 242 and infusion position 240. In some illustrative examples, seal 208 is configured to seal resin infusion chamber 232 in infusion position 240 without compression.

Infusion position 240 can also be referred to as a gap infusion position or a gap position. The terms gap infusion position or gap position may be used interchangeably with infusion position 240. Closed position 242 can also be referred to as a curing position. The term curing position may be used interchangeably with closed position 242.

Seal 208 comprises cross-sectional shape 218. In some illustrative examples, cross-sectional shape 218 comprises substantially flat first end 222 and projection 216 opposite substantially flat first end 222. Base 214 with substantially flat first end 222 is seated within channel 210 of second mold 206. In some illustrative examples, base 214 of seal 208 has substantially the same cross-sectional shape as cross-sectional shape 212 of channel 210. In these illustrative examples, cross-sectional shape 218 is substantially the same as cross-sectional shape 212. In some illustrative examples, cross-sectional shape 212 comprises flat bottom 224 and substantially parallel sides 226.

In some illustrative examples, cross-sectional shape 218 is pentagon 220 in an uncompressed state, pentagon 220 comprises substantially flat first end 222 and projection 216. Cross-sectional shape 218 comprises base 214 with substantially flat first end 222 and two substantially parallel sides.

Projection 216 takes any desirable form. In some illustrative examples, projection 216 comprises a rounded top. In some illustrative examples, projection 216 comprises an angle between two top faces. Projection 216 provides for sealing with first mold 204 without displacement or deformation of large volume of seal 208.

Seal 208 is configured to maintain pressure in at least two different positions, infusion position 240 and closed position 242. Seal 208 comprises polymeric material 213 in extruded 215 cross-sectional shape 218. Cross-sectional shape 218 comprises a substantially flat first end 222 and projection 216 opposite substantially flat first end 222.

In some illustrative examples, seal 208 is a full ring vulcanized. Having a full vulcanized ring and providing groove 228 can enable a better seal position control when it is subjected to vacuum and resin injection pressures. The design of seal 208 and optional use of groove 228 avoids the use of a large “dove tail” groove.

In some illustrative examples, resin infusion tool 202 further comprises at least one groove, groove 228, within first mold 204 configured to interface with projection 216. Groove 228 takes any desirable shape. Groove 228 can substantially mirror a shape of projection 216. In some illustrative examples, groove 228 provides a direction for deformation of seal 208 in closed position 242.

Seal 208 and other features of resin infusion tool 202 are configured to reduce or eliminate cleaning time for resin infusion tool 202 between infusion of each dry fiber preform. Seal 208 is configured to be reusable for multiple resin infusions. Seal 208 is configured to be reusable for infusion of multiple dry fiber preforms.

Resin infusion tool 202 is configured to form a thick flash, flash 254, on infused preform 252. During infusion of resin 238, resin 238 is infused into dry fiber preform 236. Excess amounts of resin 238 is present in flash formation region 234. In this illustrative example, second mold 206 has flash formation region 234 formed in close proximity to first mold 204. In some illustrative examples, seal 208 has cross-sectional shape 218 configured to compress into flash formation region 234 in closed position 242. Flash formation region 234 is configured to form a thick flash, flash 254, that will be removed from resin infusion tool 202 with infused preform 252. Flash 254 is thick enough to not break or shatter upon removal from resin infusion tool 202. The design of flash formation region 234 reduces or eliminates cleaning time for resin infusion tool 202.

In this illustrative example, first mold 204 is depicted as an upper mold and second mold 206 is depicted as a lower mold. In some illustrative examples, channel 210 is present in an upper mold. In other illustrative examples, channel 210 is present in a lower mold. In some illustrative examples, an upper mold comprises one piece. In some illustrative examples, a lower mold comprises more than one tool mandrel. Second mold 206 can comprise any desirable quantity of tool mandrels. In some illustrative examples, second mold 206 comprises one tool mandrel. In some illustrative examples, second mold 206 comprises multiple tool mandrels. When second mold 206 comprises multiple tool mandrels, seals are present between each tool mandrel for sealing resin infusion tool 202.

As depicted, second mold 206 comprises tool mandrel 207 and tool mandrel 244. In this illustrative example, channel 210 extends across both tool mandrel 207 and tool mandrel 244. In this illustrative example, seal 208 extends across both tool mandrel 207 and tool mandrel 244. Seal 208 can be referred to as a horizontal seal. When second mold 206 comprises multiple tool mandrels, the seals between the tool mandrels, such as seal 246 between tool mandrel 207 and tool mandrel 244 can be referred to as vertical seals. The horizontal seal, seal 208 is configured to seal in two different positions. Second mold 206 is sealed in a closed position prior to beginning infusion of resin 238. The vertical seal can be a conventional seal configured to seal in a single closed position.

To maintain vacuum seal 230, connection seals are present to seal the vertical seals to the horizontal seals. In this illustrative example, connection seal 248 is present in resin infusion tool 202. Connection seal 248 connects seal 208 to seal 246 to maintain vacuum seal 230 between first mold 204 and second mold 206. In some illustrative examples, connection seal 248 is molded 250. Connection seal 248 takes a shape configured to maintain vacuum seal 230.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, second mold 206 comprises more than two tool mandrels. In other illustrative examples, second mold 206 comprises a single tool mandrel. In other illustrative examples, seal 208 is present in a channel in first mold 204 while a groove configured to interface with projection 216 is present in second mold 206.

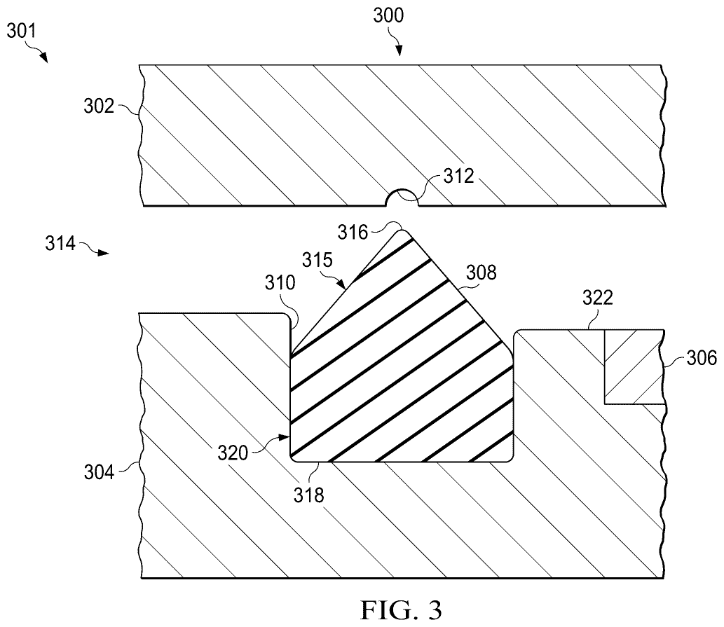

Turning now to FIG. 3, a cross-sectional view through a seal in a portion of a resin infusion tool in an open position is depicted in accordance with an illustrative embodiment. Resin infusion tool 300 is a physical implementation of resin infusion tool 202 of FIG. 2.

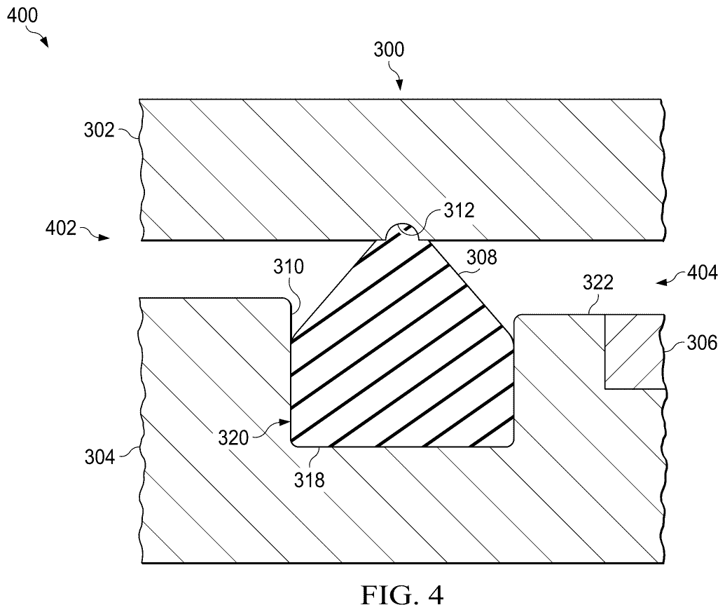

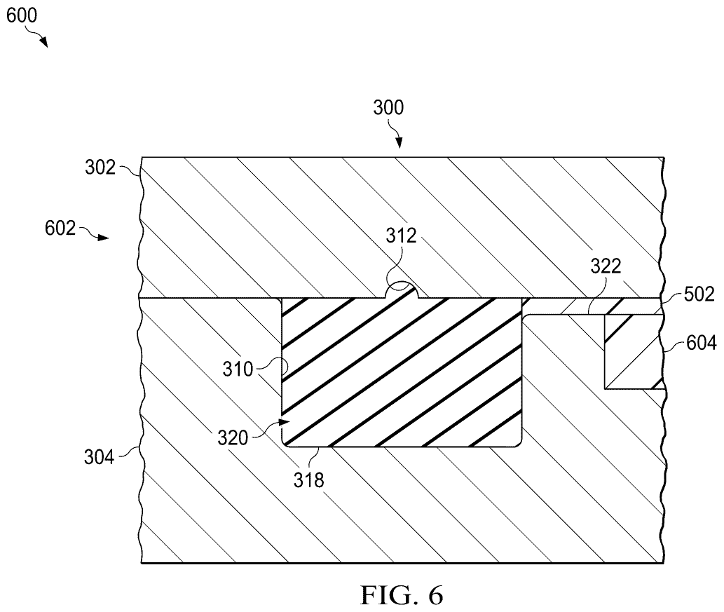

Resin infusion tool 300 comprises upper mold 302, lower mold 304 configured to form a resin infusion chamber with upper mold 302, and seal 308 seated within channel 310 of lower mold 304. Lower mold 304 comprises channel 310 around a perimeter of lower mold 304. Seal 308 is configured to maintain a vacuum seal between upper mold 302 and lower mold 304 in a infusion position, such as infusion position 402 of FIG. 4, of resin infusion tool 300. Seal 308 is also configured to maintain the vacuum seal between upper mold 302 and lower mold 304 in a closed position, such as closed position 602 of FIG. 6.

Seal 308 comprises cross-sectional shape 315 comprising a substantially flat first end 318 and projection 316 opposite substantially flat first end 318. In this illustrative example, resin infusion tool 300 comprises groove 312 within upper mold 302 configured to interface with projection 316. In this illustrative example, cross-sectional shape 315 is a pentagon in the depicted uncompressed state. The pentagon comprises substantially flat first end 318 and projection 316.

Base 320 of seal 308 has substantially the same cross-sectional shape as a cross-sectional shape of channel 310. As base 320 substantially fills channel 310, resin does not enter channel 310 during resin infusion.

In this illustrative example, a cross-sectional shape of channel 310 has a flat bottom and substantially parallel sides. To substantially fill channel 310, seal 308 has substantially parallel sides in base 320 to fill channel 310.

Lower mold 304 has flash formation region 322. Resin will flow to flash formation region 322 during resin infusion of dry preform 306. Seal 308 has cross-sectional shape 315 configured to compress into flash formation region 322 in a closed position, such as closed position 602 of FIG. 6.

Turning now to FIG. 4, a cross-sectional view through a seal in a portion of a resin infusion tool in a infusion position is depicted in accordance with an illustrative embodiment. View 400 is a view of infusion position 402. In infusion position 402, seal 308 of resin infusion tool 300 is in contact with upper mold 302. Seal 308 vacuum seals upper mold 302 to lower mold 304 in infusion position 402. Vacuum sealing upper mold 302 to lower mold 304 forms resin infusion chamber 404. Dry preform 306 is sealed within resin infusion chamber 404 for resin infusion.

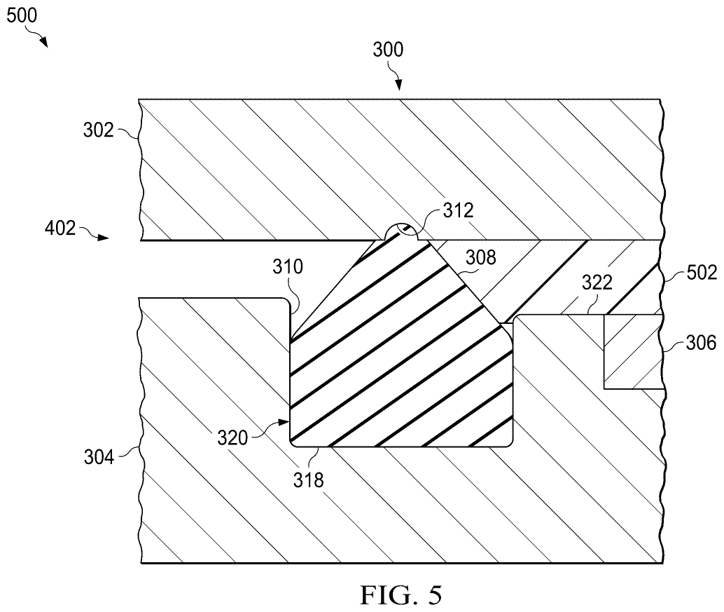

Turning now to FIG. 5, a cross-sectional view through a seal in a portion of a resin infusion tool in a infusion position is depicted in accordance with an illustrative embodiment. View 500 is a view of resin infusion tool 300 during introduction of resin 502 into resin infusion chamber 404 of resin infusion tool 300.

Turning now to FIG. 6, a cross-sectional view through a seal in a portion of a resin infusion tool in a closed position is depicted in accordance with an illustrative embodiment. In view 600 resin infusion tool 300 is in closed position 602. In closed position 602 of resin infusion tool 300 in which seal 308 is compressed.

In view 600 resin 502 has been driven into the preform to form infused preform 604. Excess amounts of resin 502 are present in flash formation region 322. Seal 308 blocks the excess resin from entering channel 310. In some illustrative examples, seal 308 is deformed to extend into a portion of flash formation region 322.

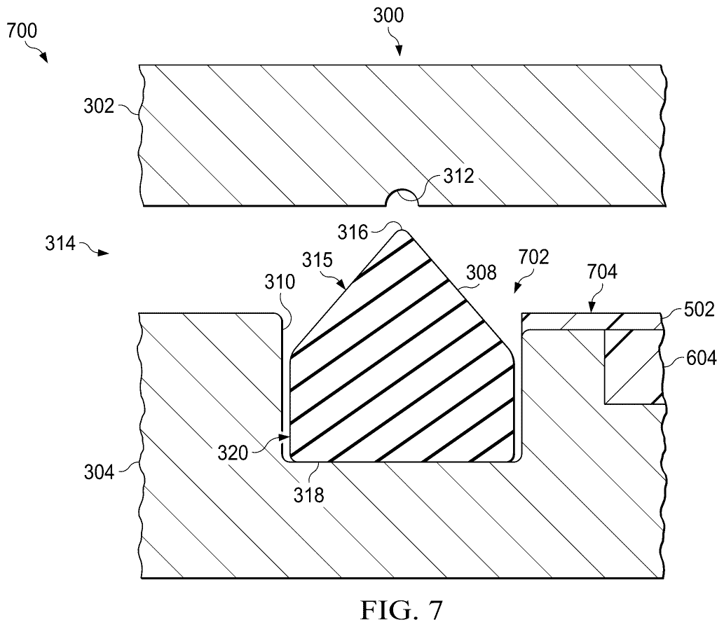

Turning now to FIG. 7, a cross-sectional view through a seal in a portion of a resin infusion tool in an open position after resin infusion is depicted in accordance with an illustrative embodiment. View 700 is a view of resin infusion tool 300 in open position 314. In view 700 seal 308 has returned to cross-sectional shape 315. By pulling away from excess resin 502, gap 702 is present between seal 308 and flash 704. Flash 704 is formed of a thick amount of resin 502. Flash 704 is attached to infused preform 604.

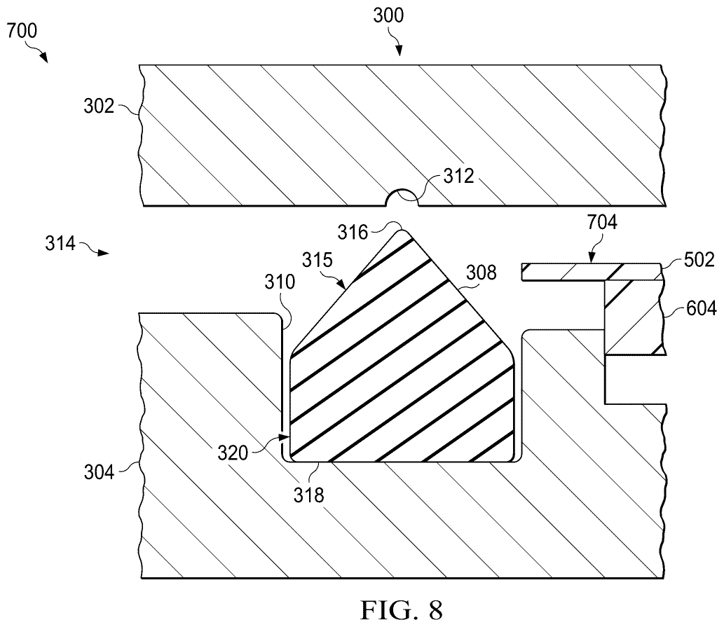

Turning now to FIG. 8, a cross-sectional view through a seal in a portion of a resin infusion tool in an open position after resin infusion is depicted in accordance with an illustrative embodiment. In view 800 infused preform 604 and flash 704 is lifted out of resin infusion tool 300. By lifting infused preform 604 and flash 704 out of resin infusion tool 300, resin infusion tool 300 is left clean. Resin is not left on lower mold 304, including channel 310.

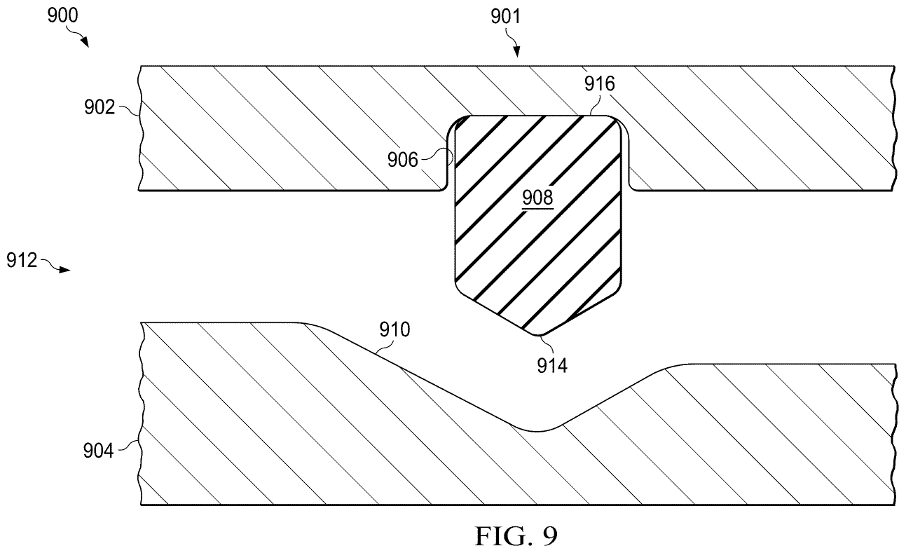

Turning now to FIG. 9, a cross-sectional view through a seal in a portion of a resin infusion tool in an open position is depicted in accordance with an illustrative embodiment. Resin infusion tool 901 is a physical implementation of resin infusion tool 202 of FIG. 2. Resin infusion tool 901 can be used to form composite parts of aircraft 100 of FIG. 1.

View 900 is a view of resin infusion tool 901 in open position 912. In this illustrative example, resin infusion tool 901 comprises upper mold 902 and lower mold 904. Seal 908 is present within channel 906 of upper mold 902.

Resin infusion tool 901 comprises upper mold 902, lower mold 904 configured to form a resin infusion chamber with upper mold 902, and seal 908 seated within channel 906 of upper mold 902. Upper mold 902 comprises channel 906 around a perimeter of upper mold 902. Seal 908 is configured to maintain a vacuum seal between upper mold 902 and lower mold 904 in a infusion position and a closed position of resin infusion tool 901.

Seal 908 comprises a cross-sectional shape comprising a substantially flat first end and projection 914 opposite the substantially flat first end. In this illustrative example, resin infusion tool 901 comprises groove 910 within lower mold 904 configured to interface with projection 914. In this illustrative example, the cross-sectional shape comprises a pentagon in an uncompressed state, the pentagon comprises the substantially flat first end and projection 914.

Base 916 of seal 908 has substantially the same cross-sectional shape as a cross-sectional shape of channel 906. As base 916 substantially fills channel 906, resin does not enter channel 906 during resin infusion.

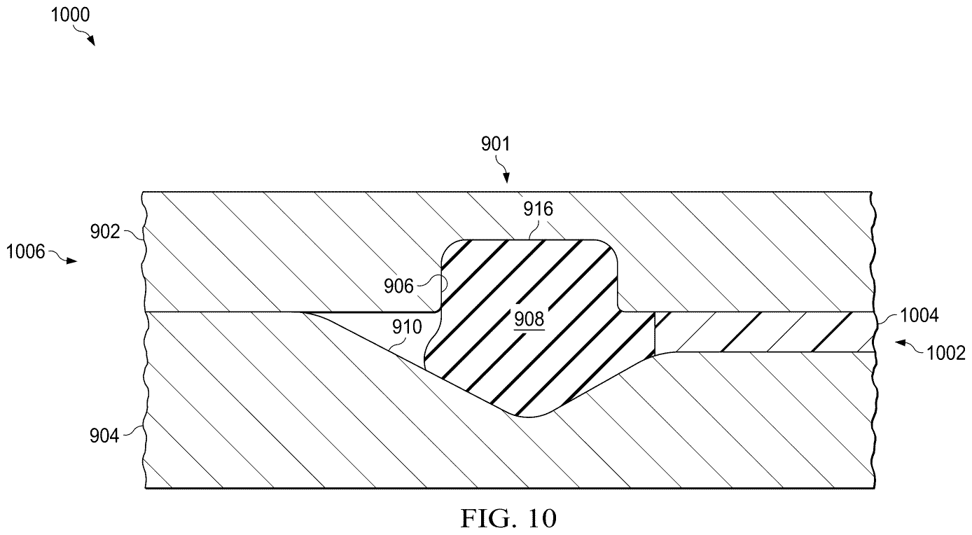

Turning now to FIG. 10, a cross-sectional view through a seal in a portion of a resin infusion tool in a closed position is depicted in accordance with an illustrative embodiment. View 1000 is a view of resin infusion tool 901 is in closed position 1006. In closed position 1006, resin 1004 has been introduced to resin infusion tool 901 to infuse a dry preform (not depicted). Resin 1004 is present in flash formation region 1002. In this illustrative example, seal 908 has been deformed by movement of at least one of upper mold 902 or lower mold 904 into closed position 1006.

With seal 908 engaged against groove 910 in lower mold 904, seal 908 has deformed into flash formation region 1002. Seal 908 has a cross-sectional shape configured to compress into flash formation region 1002 in closed position 1006.

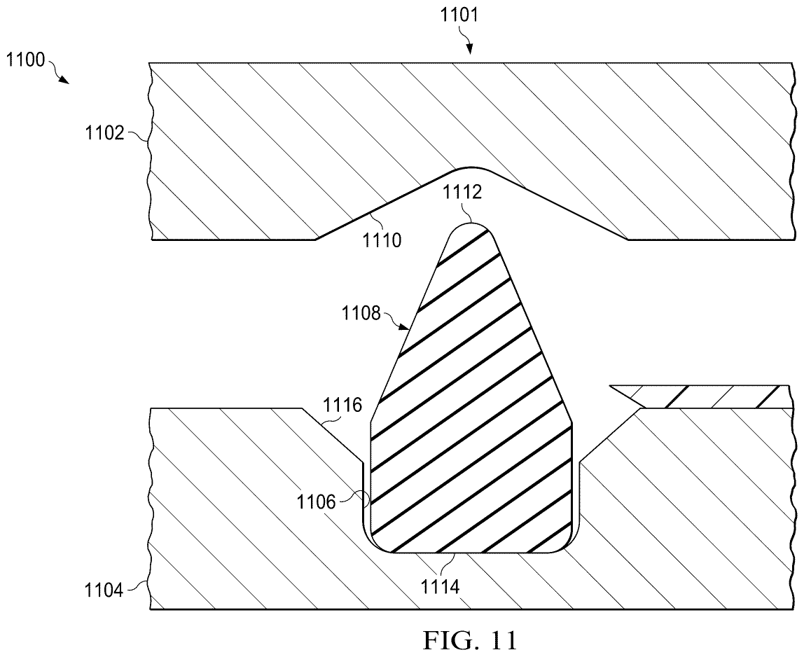

Turning now to FIG. 11, a cross-sectional view through a seal in a portion of a resin infusion tool in an open position is depicted in accordance with an illustrative embodiment. Resin infusion tool 1101 is a physical implementation of resin infusion tool 202 of FIG. 2. Resin infusion tool 1101 can be used to form composite parts of aircraft 100 of FIG. 1.

View 1100 is a view of resin infusion tool 1101 in an open position after performing a resin infusion. In this illustrative example, resin infusion tool 1101 comprises upper mold 1102 and lower mold 1104. Channel 1106 within lower mold 1104 holds seal 1108. Seal comprises base 1114 have a substantially same cross-section as channel 1106. Seal further comprises projection 1112. In this illustrative example, projection 1112 is rounded. Groove 1110 is present in upper mold 1102 and configured to interface with projection 1112.

In this illustrative example, lower mold 1104 comprises bevel 1116 around channel 1106. Bevel 1116 can accommodate seal 1108 when it is deformed by movement of resin infusion tool 1101 to a closed position.

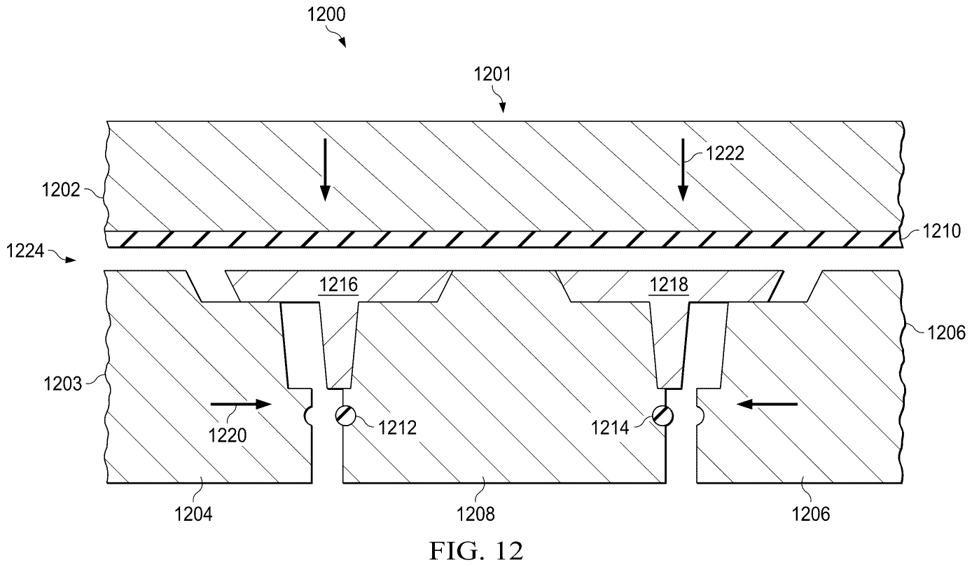

Turning now to FIG. 12, a cross-sectional view through a portion of a resin infusion tool with seals visible is depicted in accordance with an illustrative embodiment. Resin infusion tool 1201 is a physical implementation of resin infusion tool 202 of FIG. 2. Resin infusion tool 1201 can be used to form composite parts of aircraft 100 of FIG. 1.

In this illustrative example, resin infusion tool 1201 comprises upper mold 1202 and lower mold 1203. In this illustrative example, lower mold 1203 comprises tool mandrel 1204, tool mandrel 1206, and tool mandrel 1208. Resin infusion tool 1201 is in open position 1224.

In this illustrative example, conventional seals are present between the lower molds. The lower seals comprise seal 1212 between tool mandrel 1204 and tool mandrel 1208 and seal 1214 between tool mandrel 1208 and tool mandrel 1206. The lower molds are closed completely prior to resin infusion. The lower molds are closed by moving in directions 1220.

In this illustrative example, seal 1210 is a physical implementation of seal 208 of FIG. 2. Seal 1210 is configured to maintain a resin infusion chamber in resin infusion tool 1201 in both a infusion position and a closed position. The resin infusion chamber is formed by moving upper mold 1202 in direction 1222 towards lower mold 1203. In this illustrative example, seal 1210 is connected to upper mold 1202.

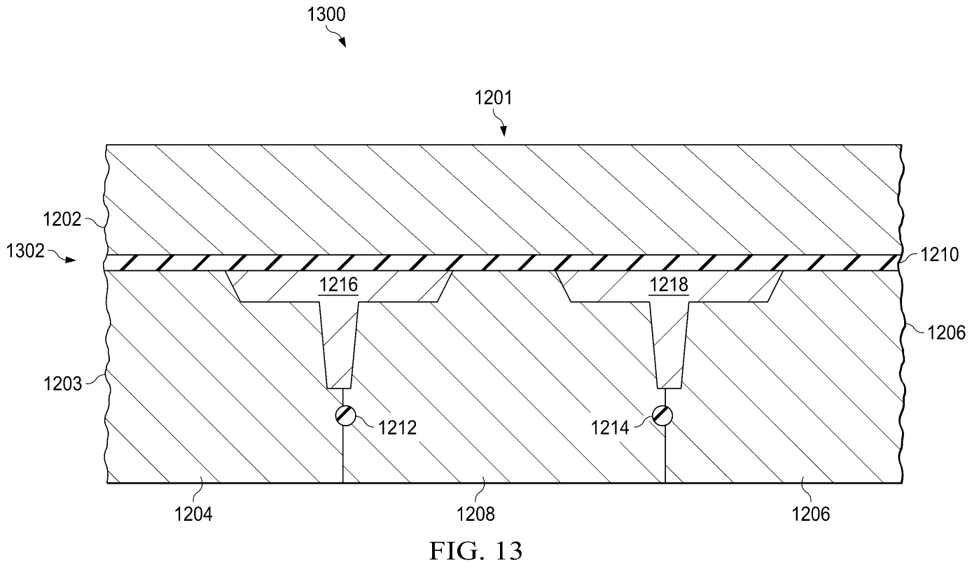

Turning now to FIG. 13, a cross-sectional view through a portion of a resin infusion tool with seals visible is depicted in accordance with an illustrative embodiment. In view 1300, resin infusion tool 1201 is in closed position 1302. In closed position 1302, tool mandrel 1204 is sealed to tool mandrel 1208 by seal 1212. In closed position 1302, tool mandrel 1206 is sealed to tool mandrel 1208 by seal 1214. Seal 1212 and seal 1214 will be connected to seal 1210 by a connection seal (not depicted).

Although seal 1212 and seal 1214 can be commercially available seals, seal 1210 and the connection seal are specific to the illustrative examples. Seal 1210 is an extruded seal while connection seal is a molded seal.

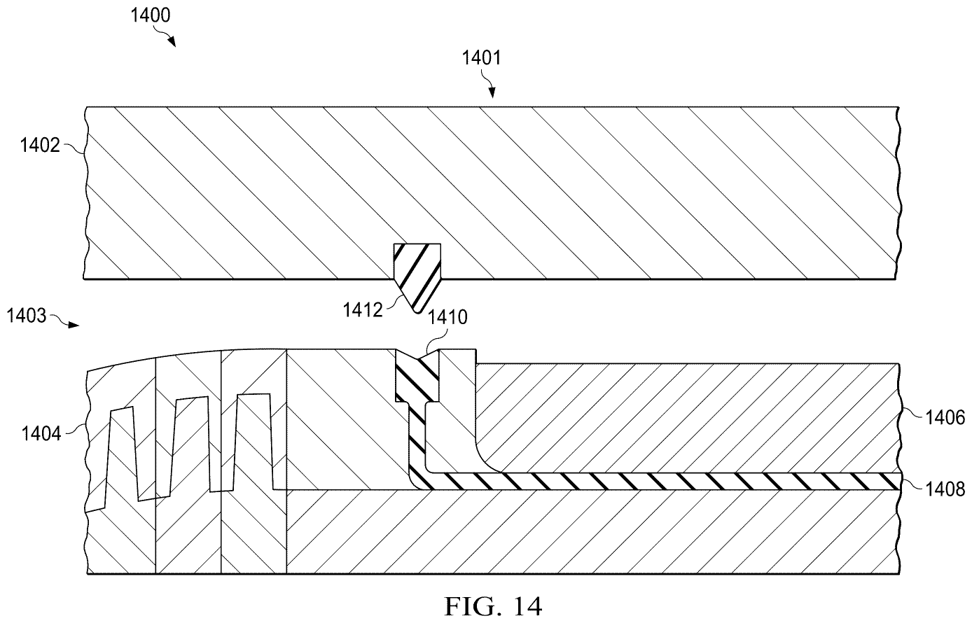

Turning now to FIG. 14, a cross-sectional view through a portion of a resin infusion tool with seals visible is depicted in accordance with an illustrative embodiment. Resin infusion tool 1401 is a physical implementation of resin infusion tool 202 of FIG. 2. In some illustrative examples, resin infusion tool 1401 can be the same as resin infusion tool 1201 of FIG. 12. In some illustrative examples, resin infusion tool 1401 can be the same as resin infusion tool 300 of FIGS. 3-8. In some illustrative examples, resin infusion tool 1401 can be the same as resin infusion tool 901 of FIGS. 9-10.

View 1400 is a view of resin infusion tool 1401 with upper mold 1402 separated from lower mold 1404 in open position 1403. Dry preform 1406 is present in resin infusion tool 1401. The interaction of the seals is displayed in view 1400. Seal 1408 is a vertical seal sealing different tool mandrels of lower mold 1404. Seal 1408 can be a conventional seal. Seal 1412 is an extruded seal having a cross-section configured to maintain a vacuum seal in both a infusion position and a closed position. Seal 1412 can be a physical implementation of seal 208 of FIG. 2. Connection seal 1410 is an implementation of connection seal 248 of FIG. 2.

The illustrative examples provide a seal-seal joint solution that enables Gap-Resin Infusion processing where movable curing mandrels are included in the tool. In this illustrative example, lower mold 1404 comprises movable curing mandrels with seal 1408.

The illustrative examples enable complex seal joints to work under typical Gap-Resin Infusion processing. The illustrative examples provide a molded seal end, connection seal 1410, for an extrusion, seal 1408, that physically connects with the main Gap Seal, seal 1412, in the tool during vacuum, infusion and compression cycles. The molded seal, connection seal 1410, can be vulcanized to one end of seal 1408. Connection seal 1410 contributes to the resin flash being removed from resin infusion tool 1401 by being connected to the infused part after it is cured. Connection seal 1410 and seal 1412 are both reusable multiple times.

Connection seal 1410 is a vulcanized end on an extruded seal, seal 1408. Connection seal 1410 can be installed in a specific groove to seal against both a tool surface and adjacent seal extrusions, seal 1412 and seal 1408. Connection seal 1410 achieves vacuum integrity and retains the resin during the various Gap-Infusion phases.

The illustrative examples present a three-surfaces joint where three independent seal lines converge. Seal 1408 is used to seal the edge of the vertical sides of the tool mandrels of lower mold 1404 and seal 1412 is installed in upper mold 1402 that closes the cavity.

All three surfaces converge in one single point where connection seal 1410 is located. Seal 1408 will deform and match with the vertical sides. Seal 1412 will contact connection seal 1410 to close the gap during vacuum and resin injection and compression phases. After the part comprising dry preform 1406 is cured, seal 1412 will return to its original shape and allow the part to be demolded without tearing or damaging the seal.

Connection seal 1410 enables the part removal and tool disassembly without having to clean resin infusion tool 1401. Connection seal 1410 enables the part removal and tool disassembly without having to perform seal replacement. Connection seal 1410 can be used repeatedly.

In some illustrative examples, connection seal 1410 comprises vulcanized ends for vertical seals, such as seal 1408, in one single piece. Connection seal 1410 can be installed either in the vertical seal ends, such as seal 1408, or the upper seal, seal 1412 at matching locations with vertical seals. Connection seal 1410 can be vulcanized on inflatable extrusions.

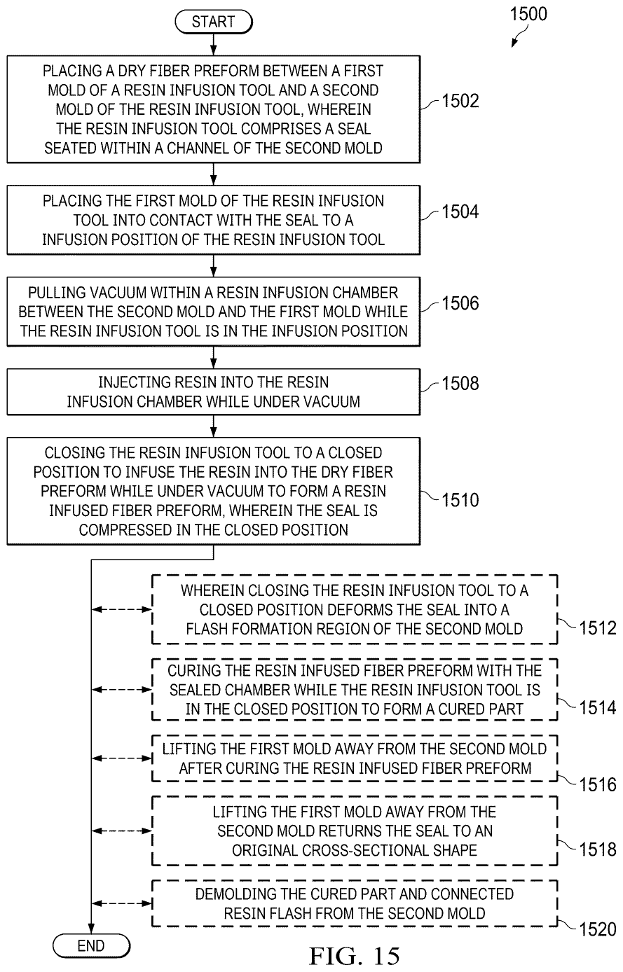

Turning now to FIG. 15, a flowchart of a method of resin transfer infusion is depicted in accordance with an illustrative embodiment. Method 1500 can be used to form a composite part of aircraft 100 of FIG. 1. Method 1500 can be performed using resin infusion tool 202 of FIG. 2. Method 1500 can be performed using resin infusion tool 300 of FIGS. 3-8. Method 1500 can be performed using resin infusion tool 901 of FIGS. 9-10. Method 1500 can be performed using resin infusion tool 1101 of FIG. 11. Method 1500 can be performed using resin infusion tool 1201 of FIGS. 12-13. Method 1500 can be performed using resin infusion tool 1401 of FIG. 14.

Method 1500 places a dry fiber preform between a first mold of a resin infusion tool and a second mold of the resin infusion tool, wherein the resin infusion tool comprises a seal seated within a channel of the second mold (operation 1502) Method 1500 places the first mold of the resin infusion tool into contact with the seal to a infusion position of the resin infusion tool (operation 1504). Method 1500 pulls vacuum within a resin infusion chamber between the second mold and the first mold while the resin infusion tool is in the infusion position (operation 1506).

Method 1500 injects resin into the resin infusion chamber while under vacuum (operation 1508). Method 1500 closes the resin infusion tool to a closed position to infuse the resin into the dry fiber preform while under vacuum to form a resin infused fiber preform, wherein the seal is compressed in the closed position (operation 1510). Afterwards, method 1500 terminates.

In some illustrative examples, closing the resin infusion tool to a closed position deforms the seal into a flash formation region of the second mold (operation 1512). In some illustrative examples, method 1500 cures the resin infused fiber preform with the resin infusion chamber while the resin infusion tool is in the closed position to form a cured part (operation 1514).

In some illustrative examples, method 1500 lifts the first mold away from the second mold after curing the resin infused fiber preform (operation 1516). In some illustrative examples, lifting the first mold away from the second mold returns the seal to an original cross-sectional shape (operation 1518). In some illustrative examples, method 1500 demolds the cured part and connected resin flash from the second mold (operation 1520).

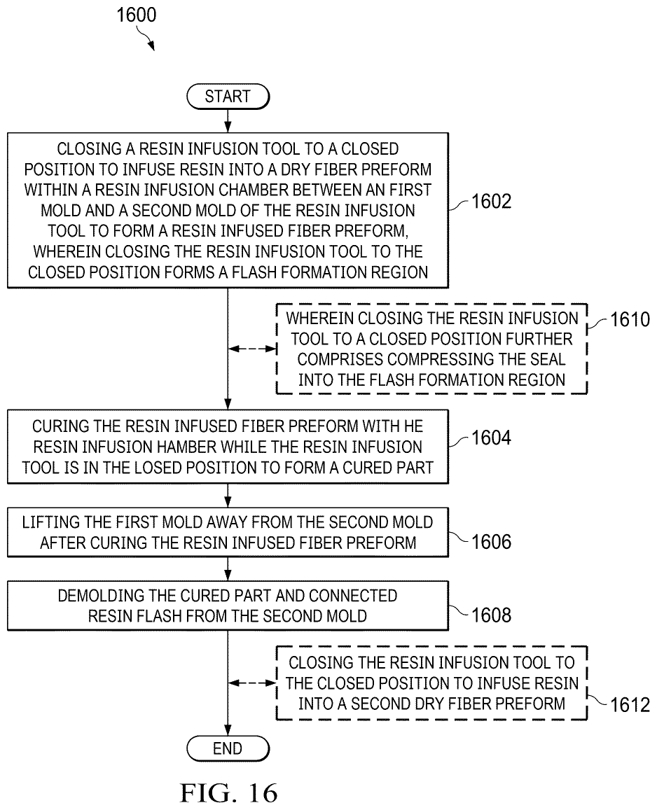

Turning now to FIG. 16, a flowchart of a method of maintaining a clean resin infusion tool is depicted in accordance with an illustrative embodiment. Method 1600 can be used to form a composite part of aircraft 100 of FIG. 1. Method 1600 can be performed using resin infusion tool 202 of FIG. 2. Method 1600 can be performed using resin infusion tool 300 of FIGS. 3-8. Method 1600 can be performed using resin infusion tool 901 of FIGS. 9-10. Method 1600 can be performed using resin infusion tool 1101 of FIG. 11. Method 1600 can be performed using resin infusion tool 1201 of FIGS. 12-13. Method 1600 can be performed using resin infusion tool 1401 of FIG. 14.

Method 1600 closes a resin infusion tool to a closed position to infuse resin into a dry fiber preform within a resin infusion chamber between a first mold and a second mold of the resin infusion tool to form a resin infused fiber preform, wherein closing the resin infusion tool to the closed position forms a flash formation region (operation 1602).

Method 1600 curing the resin infused fiber preform with the resin infusion chamber while the resin infusion tool is in the closed position to form a cured part (operation 1604).

Method 1600 lifts the first mold away from the second mold after curing the resin infused fiber preform (operation 1606). Method 1600 demolds the cured part and connected resin flash from the second mold (operation 1608). Afterwards, method 1600 terminates.

In some illustrative examples, closing the resin infusion tool to a closed position further comprises compressing a seal between the first mold and the second mold into the flash formation region (operation 1610). In some illustrative examples, method 1600 closes the resin infusion tool to the closed position to infuse resin into a second dry fiber preform (operation 1612).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1512 through operation 1520 may be optional. For example, operation operation 1612 may be optional.

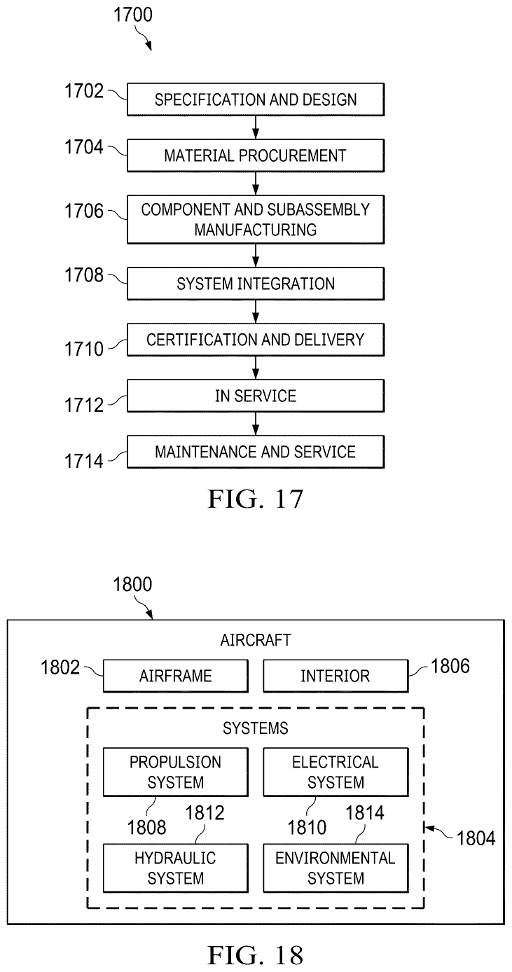

Illustrative embodiments of the present disclosure may be described in the context of aircraft manufacturing and service method 1700 as shown in FIG. 17 and aircraft 1800 as shown in FIG. 18. Turning first to FIG. 17, an illustration of an aircraft manufacturing and service method in a form of a block diagram is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 takes place. Thereafter, aircraft 1800 may go through certification and delivery 1710 in order to be placed in service 1712. While in service 1712 by a customer, aircraft 1800 is scheduled for routine maintenance and service 1714, which may include modification, reconfiguration, refurbishment, or other maintenance and service.

Each of the processes of aircraft manufacturing and service method 1700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of an aircraft in a form of a block diagram is depicted in which an illustrative embodiment may be implemented. In this example, aircraft 1800 is produced by aircraft manufacturing and service method 1700 of FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included.

Apparatuses and methods embodied herein may be employed during at least one of the stages of aircraft manufacturing and service method 1700. One or more illustrative embodiments may be manufactured or used during at least one of component and subassembly manufacturing 1706, system integration 1708, in service 1712, or maintenance and service 1714 of FIG. 17.

The illustrative examples provide a tool-seal solution that enables Gap-Resin Infusion processing. The Gap-Resin Infusion process utilizes the tool in a partially closed position, also known as a infusion position, while achieving vacuum (negative pressure). In some illustrative examples, in the partially closed position, the gap can be in the range of 2-5 mm. Compression is started after filling the gap with resin. The compression provides positive pressure. The resin infusion tool is sealed against vacuum or resin leaks during this process.

The illustrative examples provide a seal with a cross-section configured to enable a “soft” contact during the vacuum phase. The seal is configured to ensure no leaks occur during injection phase by enabling the seal to deform and fill the groove.

In the illustrative examples, the seal ensures that the resin flash will come off with the part after it is cured. The seal is reusable multiple times. The extruded seal design prevents the resin from flowing inside the channel or the groove and thus creating thin resin flash debris.

The extruded cross section will deform and fill an engineered groove where the seal will be hosted preventing the resin to flow inside the groove.

After the part is cured, the seal will return to its original shape and allow the part to be demolded without tearing or damaging the seal.

The seal extrusion prevents resin and vacuum leaks and is suited for RTM applications. Extrusion ends will be vulcanized to create one single “ring” seal.

Although the illustrative examples present a solid seal extrusion with a specific cross section, in some illustrative examples, the extrusion can use inflatable seals which can improve the seal lifespan.

The illustrative examples enable the part removal without the need to clean the tool. The illustrative examples can be used multiple times.

The illustrative examples also provide a seal-seal joint solution that enables Gap-Resin Infusion processing where movable curing mandrels are included in the tool.

The illustrative examples enable complex seal joints to work under typical Gap-Resin Infusion processing. The illustrative examples provide a molded seal end for an extrusion that physically connects with the main Gap Seal in the tool during vacuum, infusion and compression cycles. The molded seal will be vulcanized to one end of an extrusion and provides a continuation of the tool surface where tools are split due to other technology constraints.

The molded connection seal will also ensure that the resin flash will come off with the part after it is cured. The molded connection seal shall be reusable multiple times. The key aspect of the design is the ability of the molded seal to achieve vacuum integrity and retain the resin during the various Gap-Infusion phases.

The proposed invention considers a three-surfaces joint where three independent seal lines converge. The so-called vertical seal is used to seal the edge of the vertical sides of the mandrels and the upper seal is installed in the upper mold that closes the cavity. All three surfaces converge in one single point where the molded connection seal is located.

After the part is cured, the seal will return to its original shape and allow the part to be demolded without tearing or damaging the connection seal. The illustrative examples will enable the part removal and tool disassembly without the need to clean the tool and seal replacement. The connection seal will be used multiple times.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A seal configured to maintain pressure in at least two different positions comprising:
a polymeric material in an extruded cross-sectional shape, the cross-sectional shape comprising a substantially flat first end and a projection opposite the substantially flat first end.

2. The seal of claim 1, wherein the cross-sectional shape comprises a pentagon in an uncompressed state, the pentagon comprising the substantially flat first end and the projection.

3. The seal of claim 1, wherein the cross-sectional shape comprises a base comprising the substantially flat first end and two substantially parallel sides.

4. The seal of claim 1, wherein the projection comprises a rounded top.

5. The seal of claim 1, wherein the projection comprises an angle between two top faces.

6. A resin infusion tool comprising:
a first mold;
a second mold configured to form a resin infusion chamber with the first mold, wherein the second mold comprises at least one channel around a perimeter of the second mold; and
at least one seal seated within the at least one channel of the second mold, the at least one seal is seated so as to maintain a vacuum seal between the first mold and the second mold in both a infusion position and a closed position of the resin infusion tool, wherein the seal is in contact with the first mold in the infusion position, and wherein the seal is compressed in the closed position.

7. The resin infusion tool of claim 6, wherein the seal comprises a cross-sectional shape comprising a substantially flat first end and a projection opposite the substantially flat first end.

8. The resin infusion tool of claim 7 further comprising:
at least one groove within the first mold configured to interface with the projection.

9. The resin infusion tool of claim 7, wherein the cross-sectional shape comprises a pentagon in an uncompressed state, the pentagon comprising the substantially flat first end and the projection.

10. The resin infusion tool of claim 6, wherein a base of the seal has substantially the same cross-sectional shape as a cross-sectional shape of the channel.

11. The resin infusion tool of claim 6, wherein a cross-sectional shape of seal comprises a base comprising a substantially flat first end and two substantially parallel sides.

12. The resin infusion tool of claim 6, wherein the second mold has a flash formation region formed in close proximity to the first mold, and wherein the seal has a cross-sectional shape configured to compress into the flash formation region.

13. A method of resin transfer infusion comprising:
placing a dry fiber preform between a first mold of a resin infusion tool and a second mold of the resin infusion tool, wherein the resin infusion tool comprises a seal seated within a channel of the second mold;
placing the first mold of the resin infusion tool into contact with the seal to a infusion position of the resin infusion tool;
pulling vacuum within a resin infusion chamber between the second mold and the first mold while the resin infusion tool is in the infusion position;
injecting resin into the resin infusion chamber while under vacuum; and
closing the resin infusion tool to a closed position to infuse the resin into the dry fiber preform while under vacuum to form a resin infused fiber preform, wherein the seal is compressed in the closed position.

14. The method of claim 13 further comprising:
curing the resin infused fiber preform with the resin infusion chamber while the resin infusion tool is in the closed position to form a cured part.

15. The method of claim 14 further comprising:
lifting the first mold away from the second mold after curing the resin infused fiber preform; and
demolding the cured part and connected resin flash from the second mold.

16. The method of claim 15, wherein closing the resin infusion tool to a closed position deforms the seal into a flash formation region of the second mold.

17. The method of claim 15, lifting the first mold away from the second mold returns the seal to an original cross-sectional shape.

18. A method of maintaining a clean resin infusion tool comprising:
closing a resin infusion tool to a closed position to infuse resin into a dry fiber preform within a resin infusion chamber between an first mold and a second mold of the resin infusion tool to form a resin infused fiber preform, wherein closing the resin infusion tool to the closed position forms a flash formation region;
curing the resin infused fiber preform with the resin infusion chamber while the resin infusion tool is in the closed position to form a cured part;
lifting the first mold away from the second mold after curing the resin infused fiber preform; and
demolding the cured part and connected resin flash from the second mold.

19. The method of claim 18, wherein closing the resin infusion tool to a closed position further comprises compressing a seal between the first mold and the second mold into the flash formation region.

20. The method of claim 18 further comprising:
closing the resin infusion tool to the closed position to infuse resin into a second dry fiber preform.
